(19) United States
(12) Patent Application Publication
(10) Pub. No.: US 2026/0186325 A1
(43) Pub. Date: Jul. 2, 2026

(54) MULTIFOCAL DIFFRACTIVE INTRAOCULAR LENS WITH IMPROVED DESIGN FREEDOM

(71) Applicant: Alcon Inc., Fribourg (CH)

(72) Inventors: Alkan GULSES, Fort Worth, TX (US); Wei LU, Fort Worth, TX (US); Zhiguang XU, Fort Worth, TX (US); Sangyeol LEE, North Richland Hills, TX (US); Shinwook LEE, Arlington, TX (US); Jeffrey Ryan LUTKENHAUS, Fort Worth, TX (US); Nabil M. R. HOQUE, Fort Worth, TX (US)

(21) Appl. No.: 19/434,403

(22) Filed: Dec. 29, 2025

Related U.S. Application Data
(60) Provisional application No. 63/740,934, filed on Dec. 31, 2024.

(51) Int. Cl. G02C 7/04; G02C 7/02

(52) U.S. Cl. CPC G02C 7/049; G02C 7/027; G02C 7/044; G02C 2202/20

(57) ABSTRACT

An ophthalmic lens includes a diffractive structure having a plurality of echelettes. The diffractive structure is configured to provide diffracted optical energy distributions for one or more desired optical powers. At least one echelette is arranged at a radial distance from an optical axis of the ophthalmic lens such that radii of the plurality of echelettes are non-periodic. At least one echelette has a transition region connecting the at least one echelette to an adjacent echelette such that the transition region is limited to an affine power function. The diffractive structure is configured to provide first, second, and third optical energy distributions corresponding to distance, intermediate, and near vision, respectively. Advantageously the ophthalmic lens provides improved design freedom (e.g., non-periodic echelette radii, affine power transition regions), custom powers (e.g., non-integer multiples), improved optical performance (e.g., high energy utilization, MTF, and visual quality), and reduced visual disturbances (e.g., low halo effect).

### CROSS-REFERENCE TO RELATED APPLICATIONS

This application claims the benefit of U.S. Provisional Application No. 63/740,934, filed Dec. 31, 2024, which is incorporated herein by reference in its entirety.

### FIELD

The present disclosure relates to ophthalmic lens apparatuses, systems, and methods, for example, intraocular lens (IOL) apparatuses, systems, and methods with a diffractive structure for multifocal optimization.

### BACKGROUND

The human eye, in its simplest terms, functions to provide vision by transmitting light through a clear outer portion called the cornea, and focusing the resulting image by way of an ocular crystalline lens onto the retina. The quality of the focused image depends on many factors including the size and shape of the eye, and the transparency of the cornea and lens. When age or disease causes the lens to become less transparent, vision deteriorates because of the diminished light which can be transmitted to the retina. This deficiency in the lens of the eye is medically known as a cataract. In addition, the crystalline lens may lose accommodation skills with age, which is called presbyopia. An accepted treatment for those conditions is the surgical removal of the crystalline lens followed by a replacement by an IOL.

Among IOLs are multifocal diffractive IOLs. While existing multifocal diffractive IOLs may offer a range of focal points, for example, distance, intermediate, and near focal points, improvements to IOL diffractive technology may allow for increased design customization and improved outcomes for patients.

### SUMMARY

Accordingly, there is a need to develop a diffractive ophthalmic lens (e.g., an IOL) that provides custom optical powers for distance, intermediate, and near vision and increased optical performance at the desired optical powers. Further, there is a need to develop a diffractive ophthalmic lens having a sagitta (sag) profile that includes a diffractive structure of custom echelettes optimized by arbitrary radii (e.g., no periodicity restrictions) and with polynomial form in connecting one or more echelettes for improved design freedom and optimization. Further, there is a need to develop a diffractive ophthalmic lens that reduces the risk of visual disturbances (e.g., halo, starbursts, photic phenomena). Further, there is a need to develop a method to design a diffractive ophthalmic lens that provides improved visual quality across a wider range of distances (e.g., near, intermediate, distance) and that minimizes photic phenomena. This novel approach provides a customized diffractive ophthalmic lens that provides custom powers for intermediate and near focal points, improved optical performance (e.g., high energy utilization, high modulation transfer function (MTF), high visual quality), and reduced visual disturbances (e.g., low halo effect).

The novel diffractive ophthalmic lens and design optimization method described herein advantageously provides the ability to implement any desired dioptric powers while also improving overall visual quality and energy patterns at the desired powers. The novel diffractive ophthalmic lens and design optimization method described herein advantageously provides improved design freedom for lens design customization and optimization by initially having echelettes at unconstrained radii from a central axis (e.g., breaks diffraction ring diameter restrictions), with each echelette defined by a sag profile in a polynomial form (e.g., breaks linear slope restrictions) to maintain its focusing ability.

Customizing a diffractive ophthalmic lens in such a manner provides improved design freedom, while also allowing the diffractive ophthalmic lens to maintain focality due to the curved interconnecting sag structures. Further, the diffraction between the optimized echelettes generates interference patterns that create an improved energy pattern at the desired optical powers. The approach described herein is an improvement over prior approaches, in which the radii of echelettes were constrained to be at fixed increments dictated by a requirement for integer multiples of dioptric powers.

Embodiments of the present disclosure include an ophthalmic lens (e.g., an IOL) which is essentially a lens having an anterior and a posterior surface and defining an optical axis. A diffractive structure is formed on the anterior or the posterior surface. The diffractive structure can create multifocality such that a first optical energy distribution along the optical axis is formed at distance focus for distance vision; a second optical energy distribution along the optical axis is formed at intermediate focus for intermediate vision having an intermediate add power; and a third optical energy distribution along the optical axis is concentrated at near focus for near vision having a near add power, where the near add power might possibly be equivalent to a non-integer multiple of the intermediate add power.

In other embodiments, a method of forming an ophthalmic lens (e.g., an IOL) includes determining a sagitta (sag) function based on one or more dioptric power values for at least one of intermediate focus or near focus, the one or more dioptric power values being integer or non-integer multiples of one another. The method further includes determining one or more limits of the sag function including one or more of: a minimum or a maximum number of echelettes in a diffractive structure, a minimum or maximum radii of echelettes in the diffractive structure, or a total area of the diffractive structure. The method further includes determining one or more parameters of the sag function, the one or more parameters including one or more of: a radius of at least one echelette in the diffractive structure, a transition zone sag profile corresponding to the at least one echelette and an echelette adjacent to the at least one echelette. The method further includes determining values for the one or more parameters based on the one or more limits and based on the one or more desired dioptric powers for the intermediate focus or the near focus. An ophthalmic lens may then be formed based on the values for the one or more parameters.

In some embodiments, an ophthalmic lens may include an optical profile centered around an optical axis. In some embodiments, the optical profile may include a diffractive structure. In some embodiments, the diffractive structure may include a freeform surface. In some embodiments, the freeform surface may be configured to provide a first optical energy distribution along the optical axis corresponding to a distance focus for distance vision. In some embodiments, the freeform surface may be configured to provide a second optical energy distribution along the optical axis corresponding to an intermediate focus for intermediate vision having an intermediate add power. In some embodiments, the freeform surface may be configured to provide a third optical energy distribution along the optical axis corresponding to a near focus for near vision having a near add power. In some embodiments, the near add power is equivalent to a non-integer multiple of the intermediate add power.

In some embodiments, the freeform surface may be further configured to achieve one or more additional optical energy distributions along the optical axis between any of the first, second, or third optical energy distributions.

In some embodiments, the diffractive structure may include a range of 6 to 30 echelettes. In some embodiments, the diffractive structure may include a plurality of echelettes. In some embodiments, a number of the plurality of echelettes may be in a range of 2 to 30 echelettes. In some embodiments, a number of the plurality of echelettes may be in a range of 5 to 25 echelettes. In some embodiments, a number of the plurality of echelettes may be in a range of 10 to 20 echelettes. In some embodiments, a number of the plurality of echelettes may be in a range of 12 to 18 echelettes.

In some embodiments, one or more desired dioptric powers for intermediate and near focus may be determined based on patient specific visual requirements, ophthalmic conditions, ocular characteristics, or a combination thereof. In some embodiments, the ophthalmic conditions may include cataracts, presbyopia, refractive errors, aphakia, astigmatism, anisometropia, post-operative refractive error, or a combination thereof.

In some embodiments, a method of forming an ophthalmic lens may include determining a sagitta (sag) function based on one or more dioptric power values for at least one of intermediate focus or near focus. In some embodiments, the one or more dioptric power values may be integer multiples of one another. In some embodiments, the one or more dioptric power values may be non-integer multiples of one another. In some embodiments, the method may further include determining one or more limits of the sag function. In some embodiments, the one or more limits may include a minimum or a maximum number of echelettes in the diffractive structure, a minimum or a maximum radii of echelettes in the diffractive structure, a total area of the diffractive structure, or a combination thereof. In some embodiments, the method may further include determining one or more parameters of the sag function. In some embodiments, the one or more parameters may include a radius of at least one echelette in the diffractive structure, a transition zone sag profile corresponding to the at least one echelette and an echelette adjacent to the at least one echelette, or a combination thereof. In some embodiments, the method may further include determining values for the one or more parameters based on the one or more limits and the one or more dioptric power values. In some embodiments, the method may further include forming the ophthalmic lens based on the values for the one or more parameters.

In some embodiments, the one or more parameters may further include a number of echelettes, a radius of the diffractive structure, a radius of a peripheral refractive portion, a total area of the diffractive structure, or a combination thereof.

In some embodiments, the one or more limits may further include a maximum radius of the ophthalmic lens, a minimum or a maximum radius of a central diffractive portion, a minimum or a maximum radius of a peripheral refractive portion, a lens base power, a refractive index of a lens body, or a combination thereof.

In some embodiments, the method may further include determining, prior to forming the ophthalmic lens, an optical performance of the ophthalmic lens based on one or more optical parameters. In some embodiments, the one or more optical parameters may include MTF, a contrast sensitivity, an energy distribution, or a combination thereof. In some embodiments, the method may further include adjusting, based on the optical performance, the one or more parameters of the sag function.

In some embodiments, the determining the sag function based on the one or more dioptric power values for intermediate and near focus may include determining, based on optical coherence tomography (OCT) measurements of a patient, an ophthalmic biometry of an eye of the patient. In some embodiments, the determining the sag function based on the one or more dioptric power values for intermediate and near focus may further include determining a condition of the eye based on the ophthalmic biometry. In some embodiments, the determining the sag function based on the one or more dioptric power values for intermediate and near focus may further include determining, based on the condition of the eye and one or more patient specific visual requirements, a first target add power value for near focus, a second target add power value for intermediate focus, more secondary foci, or a combination thereof.

In some embodiments, the one or more parameters may further include a step height corresponding to the at least one echelette, a phase offset corresponding to the at least one echelette, or a combination thereof.

In some embodiments, an ophthalmic lens may include a diffractive structure. In some embodiments, the diffractive structure may be configured to modify a wavefront of light passing through the ophthalmic lens and provide diffracted optical energy distributions for one or more desired optical powers. In some embodiments, the diffractive structure may include a plurality of echelettes. In some embodiments, the plurality of echelettes may be configured to provide one or more diffractive steps. In some embodiments, at least one echelette may be arranged at a radial distance from an optical axis of the ophthalmic lens such that radii of the plurality of echelettes are non-periodic, and thus can be non-linear in r² space. In some embodiments, a spacing between the radii of the plurality of echelettes (e.g., spacing of diffractive rings) is non-linear in r² space. In some embodiments, at least one echelette may have a transition region connecting the at least one echelette to an adjacent echelette such that the transition region is not limited to a simple quadratic phase but an affine power function. In some embodiments, the diffractive structure may be configured to provide a first optical energy distribution along the optical axis corresponding to a distance focus for distance vision. In some embodiments, the diffractive structure may be configured to provide a second optical energy distribution along the optical axis corresponding to an intermediate focus for intermediate vision. In some embodiments, the diffractive structure may be configured to provide a third optical energy distribution along the optical axis corresponding to a near focus for near vision. In some embodiments, the diffractive structure may be configured to provide the first optical energy distribution, the second optical energy distribution, and the third optical energy distribution.

In some embodiments, each echelette may be arranged at a radial distance from an optical axis of the ophthalmic lens such that radii of the plurality of echelettes are non-periodic, and thus can be non-linear in r² space. In some embodiments, each echelette may have a transition region connecting the echelette to an adjacent echelette such that the transition region is not limited to a simple quadratic phase but an affine power function.

In some embodiments, the first, second, and third optical energy distributions may be different from one another. In some embodiments, for example, the first energy distribution may be configured to provide a distance optical power (e.g., 0 D), the second energy distribution may be configured to provide an intermediate optical power (e.g., 1.5 D), and the third energy distribution may be configured to provide a near optical power (e.g., 2.5 D). In some embodiments, the first, second, and third optical energy distributions may be spatially separated from each other along a range of defocus. In some embodiments, for example, the first energy distribution may be along a first range of defocus (e.g., 0 D to 1 D), the second energy distribution may be along a second range of defocus (e.g., 1 D to 2 D), and the third energy distribution may be along a third range of defocus (e.g., 2 D to 3 D). In some embodiments, the first, second, and third optical energy distributions may overlap with one another. In some embodiments, for example, the first and second optical energy distributions may overlap each other. In some embodiments, for example, the second and third optical energy distributions may overlap each other.

In some embodiments, the intermediate focus has an intermediate add power. In some embodiments, the near focus has a near add power. In some embodiments, the near add power is equivalent to an integer or a non-integer multiple of the intermediate add power. In some embodiments, for example, the near add power is equivalent to a non-integer multiple of the intermediate add power.

In some embodiments, the diffractive structure may be further configured to provide a fourth optical energy distribution, a fifth optical energy distribution, or both. In some embodiments, the fourth optical energy distribution may be along the optical axis between the first and second optical energy distributions, the second and third optical energy distributions, or both. In some embodiments, the fourth optical energy distribution may be along the optical axis and outside of the first, second, and third optical energy distributions. In some embodiments, for example, the fourth optical energy distribution may be outside of and not between the distance focus, the intermediate focus, and the near focus. In some embodiments, for example, the fourth optical energy distribution may be configured for a quadrifocal ophthalmic lens. In some embodiments, the fifth optical energy distribution may be along the optical axis between the first and second optical energy distributions, the second and third optical energy distributions, or both. In some embodiments, for example, the fifth optical energy distribution may be configured for a pentafocal ophthalmic lens. In some embodiments, the fifth optical energy distribution may be along the optical axis and outside of the first, second, and third optical energy distributions. In some embodiments, for example, the fifth optical energy distribution may be outside of and not between the distance focus, the intermediate focus, and the near focus. In some embodiments, the fifth optical energy distribution may be along the optical axis and outside of the first, second, third, and fourth optical energy distributions. In some embodiments, for example, the fifth optical energy distribution may be outside of and not between the distance focus, the intermediate focus, the near focus, and a fourth focus of the fourth optical energy distribution.

In some embodiments, a number of echelettes of the plurality of echelettes is in a range of 5 to 25. In some embodiments, a number of echelettes of the plurality of echelettes is in a range of 8 to 18. In some embodiments, a number of echelettes of the plurality of echelettes is in a range of 10 to 16.

In some embodiments, the transition region for the at least one echelette may be based at least in part on an affine power function with an offset, as represented by Equation (1) below:

$$z ( r ) = {ar}^{k} + b \qquad ( 1 )$$

where z(r) is displacement of the diffractive sag profile of the transition region at a radial distance r from the optical axis of the ophthalmic lens, and a, b, and k are rational numbers defining a shape of the diffractive sag profile.

In some embodiments, the transition region for each echelette may be based at least in part on an affine power function with an offset, as represented by Equation (1).

In some embodiments, the one or more desired optical powers may be based at least in part on a patient specific visual requirement. In some embodiments, the one or more desired optical powers may be based at least in part on an ophthalmic condition. In some embodiments, the one or more desired optical powers may be based at least in part on an ocular characteristic. In some embodiments, the one or more desired optical powers may be based at least in part on a patient specific visual requirement, an ophthalmic condition, an ocular characteristic, or a combination thereof.

In some embodiments, radii of the plurality of echelettes and diffractive sag profiles of the transition regions of the plurality of echelettes may be based on one or more performance metrics of the ophthalmic lens. In some embodiments, the one or more performance metrics comprises a MTF of the ophthalmic lens for a range of defocus. In some embodiments, the one or more performance metrics comprises a halo profile of the ophthalmic lens.

In some embodiments, radii of the plurality of echelettes and diffractive sag profiles of the transition regions of the plurality of echelettes are configured to increase MTF of the ophthalmic lens and to reduce a halo profile of the ophthalmic lens relative to a diffractive multifocal ophthalmic lens that utilizes integer or non-integer multiples between desired optical powers.

In some embodiments, a method of designing an ophthalmic lens having a diffractive structure may include defining a model of the ophthalmic lens based on a set of parameters. In some embodiments, the model of the ophthalmic lens may include a diffractive structure configured to provide diffracted optical energy distributions for one or more desired optical powers. In some embodiments, the method may further include defining an observable metric. In some embodiments, the method may further include performing an inverse optimization of the set of parameters such that the model of the ophthalmic lens produces the observable metric. In some embodiments, the diffractive structure may include a plurality of echelettes configured to provide one or more diffractive steps. In some embodiments, at least one echelette may be arranged at a radial distance from an optical axis of the ophthalmic lens such that radii of the plurality of echelettes are non-periodic, and thus can be non-linear in r² space. In some embodiments, at least one echelette may have a transition region connecting the at least one echelette to an adjacent echelette such that the transition region is not limited to a simple quadratic phase but an affine power function.

In some embodiments, the observable metric may include monochromatic MTF, photopic MTF, photopic peak MTF, visual acuity, a halo profile, an area under the MTF (MTFa), photopic MTFa, an optical transfer function, a point spread function, a combination thereof, or a derivative thereof. In some embodiments, the observable metric may include MTF for a range of defocus and a halo profile for the ophthalmic lens.

In some embodiments, the set of parameters defining the model may include one or more lens parameters of the ophthalmic lens, a geometry of the ophthalmic lens, the diffractive structure of the ophthalmic lens, one or more patient biometry data, or a combination thereof. In some embodiments, the one or more lens parameters of the ophthalmic lens may include the one or more desired optical powers. In some embodiments, the one or more desired optical powers may include an intermediate add power for an intermediate focus and a near add power for a near focus.

In some embodiments, the defining the model of the ophthalmic lens may include defining one or more constraints of the diffractive structure. In some embodiments, the one or more constraints may include a number of echelettes of the plurality of echelettes, a range of radial distance for each echelette, a total area of the diffractive structure, or a combination thereof. In some embodiments, the one or more constraints may further include a radial distance, a step height, a phase offset, a sag profile of the transition region, or a combination thereof of one or more echelettes of the diffractive structure.

In some embodiments, the performing the inverse optimization may include using an optimization algorithm. In some embodiments, the optimization algorithm may include gradient descent. In some embodiments, the optimization algorithm may include a genetic algorithm.

In some embodiments, the method may further include manufacturing the ophthalmic lens based on the model of the ophthalmic lens after the inverse optimization.

Implementations of any of the techniques described above may include a system, a method, a process, a device, and/or an apparatus. The details of one or more implementations are set forth in the accompanying drawings and the description below. Other features will be apparent from the description and drawings, and from the claims.

Further features and example embodiments of the present disclosure, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the relevant art(s) to make and use the embodiments.

FIG. 1 is a schematic top illustration of an IOL, according to an example embodiment.

FIG. 1A is a schematic cross-sectional illustration of the IOL shown in FIG. 1.

FIG. 2 shows a plot of a sag profile of the IOL shown in FIG. 1 as a function of radial distance from an optical axis of the IOL, according to an example embodiment.

FIG. 2A shows a plot of a sag profile of an echelette of a diffractive structure of the IOL shown in FIG. 1, according to an example embodiment.

FIG. 3A shows a plot of monochromatic (550 nm) visual acuity as a function of defocus for an exemplary IOL having a diffractive structure, according to an example embodiment.

FIG. 3B shows a plot of monochromatic (550 nm) MTF as a function of defocus at 100 line pairs per mm (lp/mm) for an exemplary IOL having a diffractive structure, according to an example embodiment.

FIG. 3C shows a plot of monochromatic (550 nm) MTF as a function of defocus at 50 lp/mm for an exemplary IOL having a diffractive structure, according to an example embodiment.

FIG. 4 is a schematic illustration of a system for designing, configuring, and forming an IOL, according to an example embodiment.

FIG. 5 illustrates a flow diagram for designing an ophthalmic lens having a diffractive structure, according to an example embodiment.

FIG. 6 illustrates a flow diagram for designing an ophthalmic lens having a diffractive structure, according to an example embodiment.

The features and example embodiments of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

Provided herein are system, apparatus, device, method, and/or computer program product embodiments, and/or combinations and sub-combinations thereof, for ophthalmic lenses, such as IOLs with diffractive structures providing multifocal optimization.

An ophthalmic lens as described below includes a diffractive structure having a plurality of echelettes to provide diffracted optical energy distributions for one or more desired optical powers, where each echelette is arranged at a radial distance from an optical axis of the ophthalmic lens such that radii of the plurality of echelettes are non-periodic, and where each echelette has a transition region connecting the echelette to an adjacent echelette such that the transition region is not limited to a simple quadratic phase but an affine power function.

The present disclosure is generally directed to an ophthalmic lens (e.g., an IOL, or contact lens) having an optical profile, such as a surface profile or embedded profile, that produces a controlled shift in optical energy distributions to optimize a performance metric (e.g., MTF) while reducing visual disturbances (e.g., halo, starburst) based on a diffractive structure (e.g., radii and shape of echelettes) of the ophthalmic lens. In the following description, lens features (e.g., diffractive structure) providing multifocal optimization are described in connection with IOLs. However, the present disclosure contemplates that those lens features may also be applied to other ophthalmic lenses, for example, but not limited to, contact lenses, spectacles, eyeglasses, or any other lenses designed to augment vision.

This specification discloses one or more embodiments that incorporate the features of this present disclosure.

The embodiment(s) described, and references in the specification to “one embodiment,” “an embodiment,” “an example embodiment,” “an exemplary embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Spatially relative terms, such as “beneath,” “below,” “lower,” “above,” “on,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values, including endpoints of ranges, can be expressed herein as approximations preceded by the term “about,” “substantially,” “approximately,” or the like. In such cases, other embodiments include the particular numerical value. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint. Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

The term “multifocal” or “multifocality” as used herein indicates a lens or multiple lenses that provide multiple focal points (e.g., multiple prescription powers) to provide clear vision at different distances. In some embodiments, a multifocal lens (e.g., trifocal, quadrifocal, pentafocal) can provide a sharp focus over a wide range of distances (e.g., near vision, intermediate vision, distance vision). In some embodiments, the multifocal ophthalmic lens may include a trifocal ophthalmic lens. In some embodiments, the multifocal ophthalmic lens may include a quadrifocal ophthalmic lens. In some embodiments, the multifocal ophthalmic lens may include a pentafocal ophthalmic lens.

The term “distance vision” as used herein indicates vision for objects that are at a calibrated distance from the viewer, for example, at least 20 feet or more from the viewer. The distance vision is for objects farther than the intermediate vision.

The term “intermediate vision” as used herein indicates vision for objects that are at a calibrated distance from the viewer, for example, between 18 inches and 20 feet from the viewer. The intermediate vision is for objects farther than the near vision.

The term “near vision” as used herein indicates vision for objects that are at a calibrated distance from the viewer, for example, 18 inches or less from the viewer. The near vision is for objects closer than the intermediate vision.

The term “photopic” or “photopic vision” as used herein indicates vision of the eye under well-lit conditions, for example, color vision in bright light or daylight conditions (e.g., luminance levels from 10 to 10⁸ cd/m²). In some embodiments, photopic light may have a central wavelength (peak sensitivity) of about 555 nm. In some embodiments, photopic MTF of an optic (e.g., an IOL) may be determined based on incoming light waves having a central wavelength of about 555 nm and span from 400 nm to 700 nm (e.g., photopic luminous efficiency function, CIE 1931 standard).

The term “modulation transfer function” or “MTF” as used herein indicates a measurement of how well a lens (e.g., an IOL) can transfer contrast at a particular resolution from an object to the resulting image. In some embodiments, MTF is a response to a periodic pattern (e.g., sine wave) passing through the IOL as a function of its spatial frequency or period (e.g., lp/mm, cycles/mm) and its orientation. MTF is the absolute value (magnitude) of the complex optical transfer function (OTF) and neglects phase effects. Values of MTF indicate how much of an object's contrast is captured in the image as a function of spatial frequency. Higher MTF values (e.g., at least 0.1) indicate better image quality and sharper details across different spatial frequencies.

The term “area under the modulation transfer function” or “MTFa” as used herein indicates a quantitative measure of the overall image quality or contrast transfer capability of a lens (e.g., an IOL) across all spatial frequencies. The area under the modulation transfer function (MTFa) is the total area enclosed by the MTF curve when plotted on a spatial frequency graph. The MTFa may be calculated by integrating the MTF curve over a specified range of spatial frequencies. The MTFa is a metric that directly correlates with the visual acuity of a lens. The larger the MTFa value (area), the better the visual acuity of the lens (e.g., MTFa value of ≥12 correlates to a visual acuity of about 0.2 LogMAR).

The term “visual acuity” or “VA” as used herein indicates a measurement of the clarity of vision. In some embodiments, visual acuity can characterize near vision, intermediate vision, and/or distance vision. Visual acuity (VA) can measure how well a viewer's eyes can distinguish shapes at a given distance via an eye exam (e.g., Snellen chart, LogMAR chart), and closely related to the concept of MTF. A Snellen chart measures visual acuity in a distance (foot) scale expressed as a ratio (e.g., 20/20, 20/25), where the numerator signifies the distance between the viewer and the chart (e.g., 20 feet), and the denominator signifies the distance at which a person with normal vision can read the same line (e.g., 20/20 is normal vision, 20/25 means the viewer can see at 20 feet what a person with normal vision can see at 25 feet). Visual acuity can be measured in different scales (e.g., foot scale, meter scale, LogMAR scale). In some embodiments, the visual acuity of a lens (e.g., an IOL) may be simulated through a simulated environment (e.g., simulated binocular VA), for example, using the American National Standards Institute (ANSI) method that provides a computer-generated test that mimics a real-life visual acuity test based on a patient's pupil size (e.g., 3.0 mm diameter).

The term “logarithm of the minimum angle of resolution” or “LogMAR” as used herein indicates a chart consisting of rows of letters to estimate visual acuity. The LogMAR chart assesses visual acuity by scoring how many letters a viewer gets wrong, with each incorrect letter on a line adding 0.02 log units to the score. The LogMAR score can be correlated to the foot score (e.g., 20/20 corresponds to 0 log units, 20/25 corresponds to 0.1 log units, 20/32 corresponds to 0.2 log units, etc.).

The term “aspheric surface” or “aspheric profile” or “aspheric equation” as used herein indicates a lens whose surface is not a portion of a sphere or cylinder and that can be characterized by Equation (2) below:

$$z ( r ) = \frac{{r}^{2}}{R ( 1 + \sqrt{1 - ( 1 + κ ) \frac{{r}^{2}}{{R}^{2}}}} + {α}_{4} {r}^{4} + {α}_{6} {r}^{6} + … \qquad ( 2 )$$

where the optical axis is in the z-direction, z(r) is the sag or z-component of the displacement of the surface from the vertex at a distance r from the optical axis, R is the radius of curvature, x is the conic constant as measured at the vertex (r=0), and coefficients ai represent the deviation of the surface from the axially symmetric quadric surface specified by R and K. In some embodiments, the coefficients ai (e.g., 4^{th}-order coefficient α₄, 6^{th}-order coefficient α₆, etc.) can be tuned or adjusted (e.g., optimized) in conjunction with a diffractive structure. In some embodiments, one or more of the coefficients ai and/or the conic constant x may be zero. In some embodiments, the conic constant k can be optimized.

The term “diffractive freedom” or “surface freedom” as used herein indicates an ability to customize echelettes of a diffractive structure with respect to one or more parameters, including but not limited to, a number of echelettes, a radial position of each echelette, a step height of each echelette, a phase offset of each echelette, a shape (e.g., sag profile) of a transition region of each echelette connecting to an adjacent echelette (e.g., echelette transition zone), or a combination thereof. Such embodiments expand the solution space used to design and optimize an ophthalmic lens with a diffractive structure. In some embodiments, for example, the diffractive freedom (e.g., radii of echelettes may be non-periodic, shape of transition regions may be not limited to a simple quadratic phase but an affine power function) may be leveraged to distribute the diffractive optical energy into desired optical powers for multifocal optimization (e.g., 0 D, 1.5 D, and 2.5 D).

The term “echelette” as used herein indicates a diffractive step or transition edge of a diffractive structure. Each echelette may include a diffractive step at a radial distance from an optical axis of the ophthalmic lens and a transition region connecting to an adjacent echelette. In some embodiments, a specific number of echelettes may be based on one or more add powers of the ophthalmic lens.

The term “diffraction coefficient” as used herein indicates an amount or degree of diffraction between echelettes that creates interference patterns that can be used to generate desired energy pattern distributions to achieve multifocality and desired energy utilization.

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, such that any difference is within an operating tolerance that is known to persons of ordinary skill in the art and provides for the desired performance and outcomes as described in the embodiments described herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

In the exemplary embodiments described herein, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Example Diffractive IOL with Custom Echelettes

One or more embodiments described herein provide a multifocal IOL, which may be configured as an ocular implant for surgical placement inside a patient's capsular bag. In some embodiments, the IOL may include a diffractive optical element comprising a number of echelettes (diffractive steps or teeth). The specific design(s) of the diffractive optical element, as included echelettes, may relate to visual performance properties, such as optical powers corresponding to one or more focal points positioned along an optical axis, and may also contribute to overall visual quality, including minimization of visual disturbances such as halo or starburst.

More specifically, some embodiments described herein provide an IOL having a diffractive optical element with diffractive echelettes configured for customization in a manner that yields multiple benefits including (1) custom powers for one or more intermediate and near focal points, (2) improved optical performance (e.g., high energy utilization, high MTF/visual quality), and (3) reduced visual disturbances (e.g., low halo effect).

In some embodiments, an IOL may be customized by initially having echelettes at unconstrained radii from a central axis wherein each echelette may be defined with a sagitta (sag) profile in a polynomial form, which is discussed in further detail below. Customizing an IOL in such a manner provides freedom for improvement of performance, while also allowing the IOL to maintain focality (i.e., ability to focus) due to the curved sag structures. The approach described herein is an improvement over prior approaches, in which the radii of the echelettes are constrained to be at fixed increments dictated by a requirement for integer multiples of dioptric powers.

Further, one or more embodiments described herein provide a method of improved freedom of design when configuring diffractive optical elements, or diffractive freedom in IOL design. As utilized herein diffractive freedom refers to the ability to customize echelettes with respect to step height, phase offset, number or echelettes, radial position of echelettes, and the mathematical form of echelette transition zones (e.g., linear, polynomial, and the like), which is described in detail below. Such embodiments expand the solution space in designing/customizing IOLs. For example, diffractive freedom may be leveraged for focusing the energy with desired dioptric powers (e.g., 0 D, 1.5 D, and 2.5 D).

Further, customizing the echelettes according to the techniques described herein allows for achieving an advantageous energy pattern at the desired optical powers. That is because customizing echelettes with respect to step height, phase offset, number or echelettes, radial position of echelettes, and the mathematical form of echelette transition zones allows for customizing the diffraction coefficient (i.e., the amount or degree of diffraction) between echelettes, which creates interference patterns that facilitate generating a desired energy pattern to achieve multifocality and a desired energy utilization.

Thus, with a customized design that takes advantage of selected IOL properties with increased diffractive freedom, IOLs in accordance with the embodiments described below may have improved visual acuity, energy efficiency, reduced halo or starburst, and general reduction of visual aberrations and/or disturbances.

As discussed above, a problem in the art is that current multifocal diffractive IOLs may limit design freedom due to certain design constraints (e.g., periodic diffractive ring diameter, linear echelette transition zones, integer multiple optical powers, etc.), and diffractive IOLs attempting to provide multifocal (e.g., trifocal) optimization suffer from increased photic phenomena (e.g., halo) as a result of using diffractive elements. Also, some current IOL designs are not optimized for increased design customization (e.g., optimization of any desired optical powers) and improved outcomes for patients (e.g., minimization of halo disturbances).

In order to address this problem, the systems and methods of the present disclosure provide a customized ophthalmic lens (e.g., IOL) that utilizes an effective diffractive structure whose design (e.g., position, number, and shape of echelettes) is optimized to provide a wider multifocality (e.g., trifocal, quadrifocal, pentafocal) to provide a sharp focus over a wide range of distances for any desired optical powers (e.g., 0 D, 1.5 D, and 2.5 D) and reduced risk of visual disturbances (e.g., photic phenomena). The described diffractive structure mitigates the above problems by removing previous design constraints such that radii of the echelettes are non-periodic and transition regions (e.g., sag profiles) of echelettes between adjacent echelettes are not limited to a simple quadratic phase but an affine power function. This provides an improvement to ophthalmic lens design technology by expanding the diffractive freedom for improved customization of optical powers and providing clear multifocal vision across a wider range of distances (e.g., near, intermediate, distance). Further, the described diffractive structure also mitigates the risk of visual disturbances and multifocality problems by optimizing the echelettes (e.g., radii and shape of echelettes) to one or more performance metrics (e.g., MTF and halo profile) to optimize diffracted optical energy distributions for one or more desired optical powers. This also provides an improvement to ophthalmic lens design technology by reducing photic phenomena (e.g., glare, halo, artifacts, etc.) while maintaining optimal multifocality.

Embodiments of IOL apparatuses, systems, and methods as discussed below can provide improved design freedom (e.g., non-periodic echelette radii, affine power function transition regions), custom powers for one or more intermediate or near focal points (e.g., non-integer multiples), improved optical performance (e.g., high energy utilization, MTF, and visual quality), and reduced visual disturbances (e.g., low halo effect). This novel approach can provide a customized IOL that utilizes an effective diffractive structure to provide improved design freedom for lens design customization and optimization, and provide the ability to implement any desired optical powers while also improving overall visual quality and energy patterns at the desired powers.

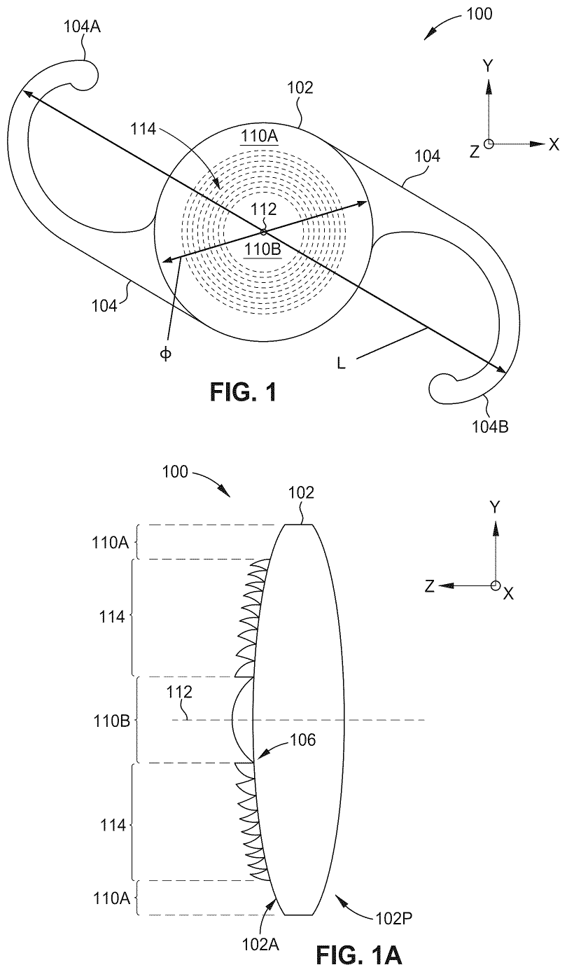

Referring now to FIGS. 1 and 1A, FIG. 1 depicts a top view of an IOL 100, according to one or more embodiments. FIG. 1A depicts a side view of a cross-sectional view of lens body 102 of IOL 100. As shown in FIG. 1, IOL 100 includes lens body 102, haptic portion 104, peripheral refractive element 110A, optical axis 112, and diffractive structure 114, where the echelettes of the diffractive structure may not be shown to scale. As shown, the lens body 102 includes an anterior surface 102A and posterior surface 102P. The lens body 102 further includes a central portion 110B on each of the anterior surface 102A and the posterior surface 102P.

In some embodiments, lens body 102 may be fabricated of biocompatible material, such as modified poly(methyl methacrylate) (PMMA), modified PMMA hydrogels, hydroxy-ethyl methacrylate (HEMA), PVA hydrogels, other silicone polymeric materials, and hydrophobic acrylic polymeric materials, for example, AcrySof® and Clareon®, available from Alcon, Inc., Fort Worth, Texas. In some embodiments, lens body 102 has a diameter φ in the range of substantially 4.9 mm to 6.5 mm. In some embodiments, lens body 102 has a diameter φ of between about 4.5 mm and about 7.5 mm.

In FIGS. 1 and 1A, the shape and curvatures of lens body 102 are shown for illustrative purposes only and some embodiments include other shapes and curvatures, which are within the scope of the embodiments described herein. For example, lens body 102 shown in FIG. 1A has a bi-convex shape. In other embodiments, lens body 102 may have a plano-convex shape, a convexo-concave shape, or a plano-concave shape.

As shown in FIG. 1, haptic portion 104 may include radially-extending struts (also referred to as “haptics”) 104A and 104B that are coupled (e.g., glued or welded) to the peripheral portion of lens body 102 or molded along with a portion of lens body 102, and thus extend outwardly from lens body 102 to engage the perimeter wall of the capsular bag of the eye. In some embodiments, haptic portion 104 and lens body 102 form a unitary, monolithic feature, which requires no gluing or welding. In some embodiments, haptics 104A and 104B may be fabricated of biocompatible material, such as modified PMMA, modified PMMA hydrogels, HEMA, PVA hydrogels, other silicone polymeric materials, and hydrophobic acrylic polymeric materials, for example, AcrySof® and Clareon®, available from Alcon, Inc., Fort Worth, Texas. Haptics 104A and 104B typically have radial-outward ends that define arcuate terminal portions.

The terminal portions of haptics 104A and 104B may be separated by a length L of between about 6 mm and about 22 mm, for example, about 13 mm. Haptics 104A and 104B have a particular length so that the terminal portions create a slight engagement pressure when in contact with the equatorial region of the capsular sac after being implanted. While FIG. 1 depicts one example configuration of haptics 104A and 104B, any plate haptics or other types of haptics can be used.

In some embodiments, IOL 100 is a multifocal lens having multiple focal points (e.g., bifocal, trifocal, quadrafocal, or pentafocal), which is characterized by base curvature 106 and diffractive structure 114 formed on anterior surface 102A of lens body 102, as shown in FIG. 1A. Diffractive structure 114 diffracts an incident light into multiple diffraction orders and the light energy, power, or intensity of the incident light is divided into those multiple diffraction orders. Thus, a diffraction efficiency of each diffraction order is less than 100%. Although diffractive structure 114 is shown only on anterior surface 102A of lens body 102, diffractive structure 114 may, in some embodiments, be formed on posterior surface 102P of lens body 102, on both of anterior surface 102A and posterior surface 102P of lens body 102, or may be formed or embedded within a portion of lens body 102.

In some embodiments, the diffractive structure 114 distributes the optical energy mainly to distance, intermediate, and near focal points. In some embodiments, some optical energy may be distributed to positions between the distance, intermediate, and near focal points to provide bridging (e.g., intermediate) energy, e.g., providing some vision correction at these positions as well. All echelettes in the diffractive structure 114 may work together to cause constructive interference to send light to the desired diffraction orders associated with the intended focal points.

In some embodiments, peripheral refractive element 110A may surround diffractive structure 114 and may be centered at optical axis 112 of lens body 102.

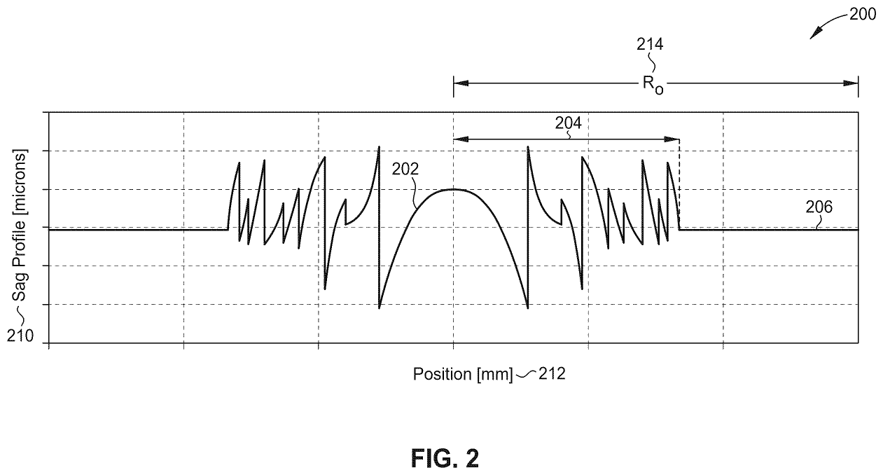

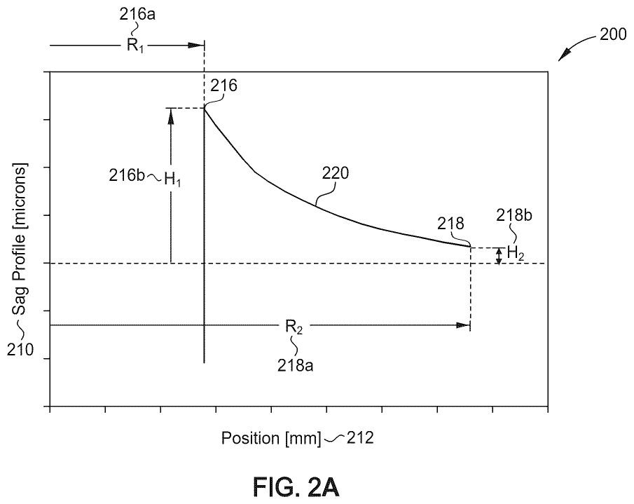

The central portion 110B of the anterior surface 102A and/or the posterior surface 102P of the lens body 102 may be configured in a variety of ways. For example, the central portion 110B may be considered to be yet another echelette and part of the diffractive structure 114. Accordingly, the sag profile, radius, and other properties (see FIG. 2A) of the central portion 110B may be selected in the same manner and as part of the same design procedure used for customizing the properties of the echelettes of the diffractive structure 114 as described herein.

Referring now to FIG. 2 in conjunction with FIGS. 1 and 1A, FIG. 2 depicts sag profile 200. FIG. 2 shows a plot of sag profile 200 of IOL 100 with sag profile (μm) 210 as a function of position (mm) 212 (e.g., radial distance) from optical axis 112. As shown in FIG. 2, sag profile 200 is one exemplary embodiment of an optical profile associated with the IOL 100. For example, the sag profile 200 may include a diffractive structure 204 having echelettes corresponding to the diffractive structure 114 of FIG. 1, which includes a central diffractive element 202 corresponding to the central portion 110B. The sag profile 200 may further include a peripheral refractive element 206 having a radius Rₒ 214, the peripheral refractive element 206 corresponding to the peripheral refractive element 110A.

In some embodiments, Rₒ 214 of the peripheral refractive element 206 may be smaller than 1.5 mm, between 1.5 and 3.0 mm, or greater than 3.0 mm.

In some embodiments, based on the average pupil size of most patients, the diffractive structure may include 6 to 30 echelettes. In the examples described below, the central diffractive element 202 may be considered to be an echelette. For example, the properties of the central diffractive element 202 may be selected to be similar to the properties of the other echelettes of the diffractive structure 204.

In some embodiments, one or more optical profiles of IOL 100 may be described by the following sagitta (sag) profile, as represented by Equation (3) below:

$${Sag}_{total} = {Sag}_{refractive} + {Sag}_{diffractive} \qquad ( 3 )$$

where refractive sag, Sag_{refractive}, may be defined, with respect to radial distance r by Equation (4) below:

$$Sag ( r ) = \frac{{cr}^{2}}{1 + \sqrt{1 - ( 1 + κ ) {c}^{2} {r}^{2}}} , 0. \leq r \leq 3. mm \qquad ( 4 )$$

In Equation (3) above, Sag_{refractive} is the height from an aspheric surface from which the echelettes extend and is a function of r² (where r is the radius from the center (i.e., optical axis 112)). In Equation (4), c is the curvature (i.e., inverse of radius) of the lens surface (e.g., anterior surface 102A). As shown by Equation (4), the aspheric refractive sag is controlled by the parameter, κ, the conic constant.

The diffractive sag, Sag_{diffractive}, is defined by (i) radii of the echelettes and (ii) the sag profile of transition regions (e.g., transition regions 220) between adjacent echelettes. In some embodiments, Sag_{diffractive} may adjust the dioptric powers, which are dependent upon the radii of the echelettes (e.g., radius of the n^{th} diffractive ring, r(n)).

In some embodiments, radius of the n^{th} diffractive ring, r(n), may be represented by Equation (5) below:

$$r ( n ) = \sqrt{\frac{2 n λ}{D}} n = 1 , 2 , 3 , … \qquad ( 5 )$$

In Equation (5), λ is a wavelength in the IOL medium (e.g., 550 nm), n is the ring index number (e.g., n=1, 2, 3 . . . n number of echelettes), and D is the desired diopter for the add power. The desired diopter may be determined by evaluating a patient's visual acuity (VA) and providing a desired diopter value to accommodate the needs of the individual patient. Thus, in some embodiments, Equation (5) may be modeled and used for adjusting the lens powers of a custom IOL (e.g., IOL 100). In some embodiments, such customization may include adjusting step heights of individual echelettes for tuning the distribution of light between distant and add power. For example, the step heights of the echelettes may vary from one echelette to another or may be constrained to be constant across the surface of the lens body.

In some embodiments, Equation (5) is not used. Instead, the IOL may be modeled based on custom powers without specific relations between them (e.g., no periodic restrictions), upon employing custom positions and step heights of the echelettes. Therefore, the quadratic (r²) periodicity of ring diameters constraint may now, advantageously, be removed.

Implementing Equation (5) for determining radius values for diffractive rings based on desired dioptric powers may be advantageous for bifocals. However, for trifocal IOLs (e.g., IOL 100), Equation (5) imposes constraints, such that the dioptric powers for near add power must be an integer multiple of intermediate add power. Such constraints may be seen in Equation (5) as n is a set of integers that constrains the diopter value, D.

In some embodiments, the ability to implement any desired arbitrary dioptric powers may be advantageous. As utilized herein, arbitrary dioptric power refer to dioptric powers that are not whole integer multiples of one another. For example, arbitrary dioptric powers that may be desired include 1.5 D for intermediate focus and 2.5 D for near focus (e.g., with respect to spectacle plane). In some embodiments, in order to determine IOL parameters to achieve desired dioptric powers, desired dioptric powers are selected and then based on the desired selected dioptric powers, parameters of the surface of the IOL (e.g., diffractive structure 114, central portion 110B, peripheral refractive element 110A, FIG. 1A) may then be determined by imposing new conditions (e.g., number of echelettes, radius of echelettes, shape of transition zone between adjacent echelettes) with the desired dioptric powers.

In FIG. 2, sag profile 200 includes Sag_{diffractive} and corresponds to Sagₜₒₜₐₗ of Equation (3) above, and includes dioptric power values at 1.5 D and 2.5 D for near and intermediate focus, respectively (with respect to corneal plane). In sag profile 200, two parameters that may be initially considered are radii for the diffractive rings, and the connecting sag (i.e., sag profile of transition zone of adjacent echelettes) between those radii. Radii of the echelettes may be selected by making the radii floating node variables, and via an optimization algorithm (e.g., gradient descent, genetic algorithm), determining radii values for each echelette such that IOL 100 may perform substantially at the desired dioptric powers. In order to do so, the diffractive sag profile, Sag_{diffractive}, of the transition regions 220 between echelettes may be improved, as shown in FIG. 2A and represented by Equation (6) below:

$$z ( r ) = {ar}^{k} + b \qquad ( 6 )$$

where z(r) is displacement of the diffractive sag profile of the transition region 220 at a radial distance r from the optical axis of the ophthalmic lens, and a, b, and k are rational numbers defining a shape of the diffractive sag profile.

Referring now to FIG. 2A, FIG. 2A depicts a portion of sag profile 200, illustrating a transition zone (e.g., transition region 220) of a first echelette 216 between first echelette 216 and a second echelette 218 of diffractive structure 114. First echelette 216 may have a radius of R₁ 216a from the optical axis (e.g., optical axis 112 shown in FIG. 1) and second echelette 218 may have a radius of R₂ 218a, from the optical axis (e.g., optical axis 112 shown in FIG. 1). As shown in FIG. 2A, first echelette 216 includes transition region 220 connecting first echelette 216 to second echelette 218. First echelette 216 further has a step height H₁ 216b at the radius of R₁ 216a and a valley height H₂ 218b at the radius of R₂ 218a of the second echelette 218. In some embodiments, other echelettes of diffractive structure 114 may have analogous step and valley heights similar to first echelette 216 shown in FIG. 2A (e.g., similar step height H₁ 216b at the radius of R₁ 216a and valley height H₂ 218b at the radius of R₂ 218a of the adjacent echelette). In Equation (6), z(r) defines the portion of the diffractive sag profile between steps of each echelette with different parameters of a, b, and k, depending on the radial dimension denoted by r. Thus, by removing the constraint of Equation (5) of multiple integers, the radii for echelettes are determined through an optimization algorithm (e.g., gradient descent, genetic algorithm) by using the diffractive sag profile in Equation (6) and selecting values of a, b, and k according to the optimization algorithm for each echelette.

As is apparent in the above discussion, the design of the diffractive structure 204 of the sag profile 200 includes up to four degrees of freedom for each echelette: the number of variables defining polynomial form of the transition regions 220 (e.g., a, k, and b in Equation (6)) between adjacent echelettes and the radius of each echelette. Accordingly, there are at least 4*N degrees of freedom in the design of the diffractive structure 204, assuming N echelettes. Other degrees of freedom may include the number of echelettes N, step height of each echelette (e.g., step height H₁ 216b shown in FIG. 2A), and valley height of each echelette (e.g., valley height H₂ 218b shown in FIG. 2A). An optimization algorithm may use some or all of these degrees of freedom to improve figures of merit for the resulting IOL 100, such as improving a MTF, improving energy distribution along the optical axis 112, and reducing visual aberrations (e.g., halo) all while achieving the desired diopter values.

For example, the optimization algorithm may use the surface freedom provided by the variables for Equation (6) for each echelette as well as the other parameters defining the echelettes to achieve a freeform surface having a first optical energy distribution along the optical axis 112 that is concentrated at distance focus for distance vision; a second optical energy distribution along the optical axis 112 that is concentrated at intermediate focus for intermediate vision having an intermediate add power; and a third optical energy distribution along the optical axis 112 that is concentrated at near focus for near vision having a near add power, the near add power being equivalent to an integer or non-integer multiple of the intermediate add power. The freeform surface may additionally achieve one or more additional optical energy distributions along the optical axis between any of the first, second, and third energy distributions.

### Example Performance Metrics of Diffractive IOL

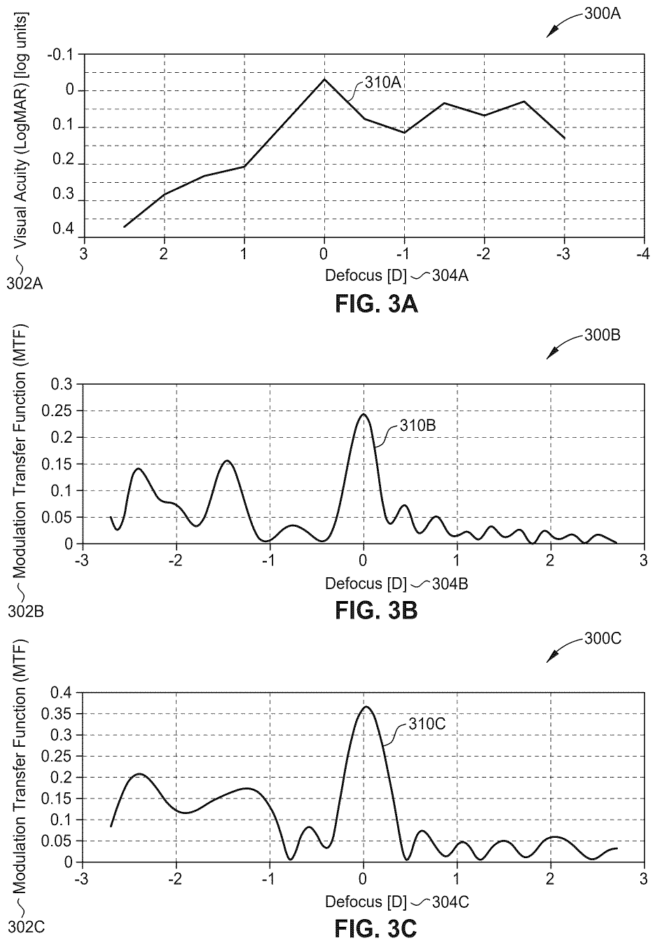

Referring now to FIGS. 3A-3C, FIGS. 3A-3C depict performance metrics of an exemplary IOL 100 in accordance with one or more embodiments described herein. In some embodiments, FIGS. 3A-3C may be generated based on sag profile 200. FIG. 3A depicts a plot 300A showing visual acuity (VA) (LogMAR) 302A as a function of defocus (diopter D) 304A for an exemplary IOL, in accordance with one or more embodiments discussed above. Specifically, FIG. 3A depicts a VA distribution 310A for a monochromatic binocular VA, 3 mm pupil size, in accordance with some embodiments.

Considering echelette radii from the center, some conventional IOLs include a linear pattern for echelettes in the r² space based on Equation (5). However, in some embodiments, the constraint of a linear pattern for echelettes in the r² space is removed. For example, a spacing between radii of the echelettes (e.g., spacing of diffractive rings) may be non-linear in r² space. In doing so, the operational space of freedom (e.g., diffractive freedom) is expanded. As utilized herein, the operational space of freedom refers to features of the IOL that may be adjusted to improve overall VA of the IOL. Moreover, by implementing the embodiments herein, custom, or arbitrary, powers of intermediate and near focuses may be achieved, with high energy utilization, high MTF, and/or reduced halo and visual disturbances, in general.

In FIG. 3A, a lower LogMAR number corresponds to better vision, and as VA becomes better, the value of the LogMAR decreases. As shown in FIG. 3A, the embodiments described herein utilizing sag profile 200 provide superior VA at all distance, intermediate, and near foci, which are at about 0 D, 1.5 D, and 2.5 D, respectively, as chosen by the designer, with respect to corneal plane (e.g., approximately around 2.1 D and 3.4 D, with respect to IOL plane, and those do not have to be related as imposed by Equation (5)). As shown in FIG. 3A, some embodiments herein may advantageously provide an IOL having a LogMAR value of 0.1 or less for near, intermediate, and far distance vision.

FIGS. 3B-3C depict plots 300B, 300C, respectively, showing through-focus MTF, for 100 lp/mm, 3 mm pupil size, and 50 lp/mm, 3 mm pupil size, respectively. FIG. 3B shows a plot 300B of through-focus MTF distribution 310B for an exemplary IOL. As shown in FIG. 3B, plot 300B shows monochromatic (550 nm) through-focus MTF (unitless) 302B as a function of defocus (diopter D) 304B at 100 lp/mm for a 3 mm aperture (e.g., pupil size). FIG. 3C shows a plot 300C of through-focus MTF distribution 310C for an exemplary IOL. As shown in FIG. 3C, plot 300C shows monochromatic (550 nm) through-focus MTF (unitless) 302C as a function of defocus (diopter D) 304C at 50 lp/mm for a 3 mm aperture (e.g., pupil size). In the context of an IOL 100, MTF describes the contrast between light and dark areas in the image as a function of the spatial frequency. A higher MTF value for a specific spatial frequency means that IOL 100 can reproduce finer details with higher contrast at that frequency. When evaluating an IOL, the MTF can provide insight into its performance regarding image sharpness, contrast, and overall visual quality. A lens with a high MTF can better reproduce fine details in the image, leading to improved visual outcomes for patients. MTF can be influenced by various factors, such as lens design, materials, manufacturing quality, and the presence of aberrations. As shown in FIG. 3A and FIG. 3B, in some embodiments, IOL 100 diffractive orders can be configured to yield intermediate point at 1.5 D and near point at 2.5 D.

### Example System for Designing Diffractive IOL

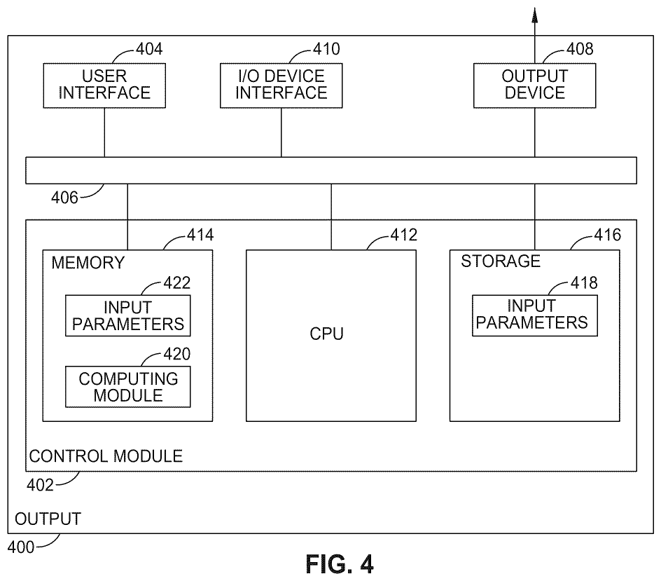

Referring now to FIG. 4, FIG. 4 depicts system 400 for designing, configuring, and/or forming IOL 100. As shown, system 400 includes, without limitation, controller 402, user interface display 404, interconnect 406, output device 408, and at least one I/O device interface 410, which may allow for the connection of various I/O devices (e.g., keyboards, displays, mouse devices, pen input, etc.) to system 400. While one or more operations are described herein as being performed by particular components of system 400, those operations may, in some embodiments, be performed by other components of system 400. As an example, while one or more operations are described herein as being performed by CPU 412, memory 414, and/or storage 416 those operations may, in other embodiments, be performed by other components of system 400 (e.g., CPU 412, memory 414, and/or storage 416).

In some embodiments, controller 402 includes a central processing unit (CPU) 412, memory 414, and storage 416. The CPU 412 may retrieve and execute programming instructions stored in memory 414. Similarly, CPU 412 may retrieve and store application data residing in memory 414. Interconnect 406 transmits programming instructions and application data, among CPU 412, I/O device interface 410, user interface display 404, memory 414, storage 416, output device 408, etc. In some embodiments, CPU 412 may correspond to a single CPU, multiple CPUs, or single CPU having multiple processing cores. Additionally, in some embodiments, memory 414 represents volatile memory, such as random-access memory. In other embodiments, storage 416 may be non-volatile memory, such as a disk drive, solid state drive, or a collection of storage devices distributed across multiple storage systems.

As shown, storage 416 includes input parameters 418. Input parameters 418 include a number of echelettes, an affine power function form of echelette transition zones, the parameters including a, b, and k of Equation (6) above, a diffractive structure radius, lens body base power, lens body refractive index, near add power, intermediate add power, and/or spherical aberration correction. Memory 414 includes computing module 420 for computing control parameters, such as values for a, b, and k of Equation (6), echelette radii, step heights and phase offsets of echelettes in a diffractive structure (e.g., diffractive structure 114). In addition, memory 414 includes input parameters 422.

In some embodiments, input parameters 422 correspond to input parameters 418 or at least a subset thereof. In some embodiments, during the computation of the control parameters, input parameters 422 are retrieved from storage 416 and executed by CPU 412 and memory 414. In such an example, computing module 420 includes executable instructions for computing the control parameters, based on input parameters 422. In other embodiments, input parameters 422 may correspond to parameters received from a user via user interface display 404. In such embodiments, computing module 420 includes executable instructions for computing the control parameters, based on information received from the user interface display 404.

In some embodiments, the computed control parameters are output, via output device 408. A lens manufacturing system receives the control parameters and manufactures a lens according to the control parameters. In other embodiments, system 400 itself is representative of at least a part of a lens manufacturing system. In such embodiments, controller 402 then causes hardware components (not shown) of system 400 for forming an IOL according to the control parameters. The details of an IOL manufacturing system are known to one of ordinary skill in the art and are omitted herein for brevity.

### Example Flow Diagram

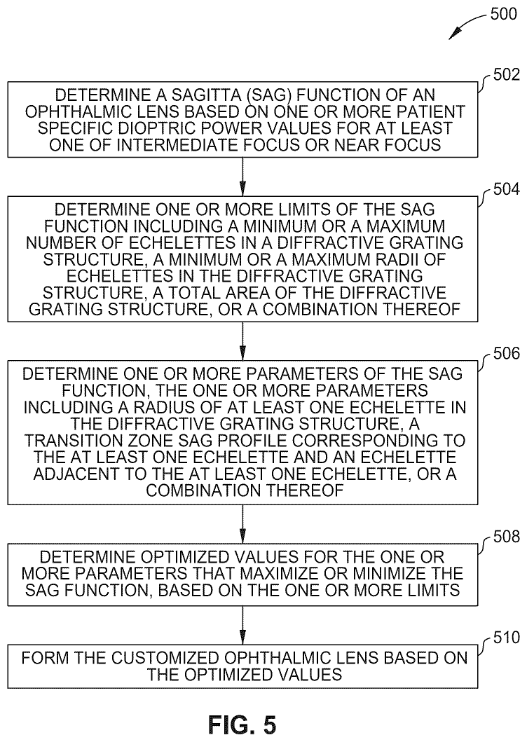

Referring now to FIG. 5 in conjunction with FIGS. 1-4, FIG. 5 depicts a method 500 of forming an IOL. The method 500 may implement a selection of input parameters, such as defined above with respect to FIG. 4 (e.g., transition zones between adjacent echelettes and echelette radii).

In some embodiments, method 500 may begin at operation 502 by determining an initial sag function based on one or more dioptric power values for at least one of intermediate focus or near focus. As mentioned above, the one or more dioptric powers may be desired dioptric powers that are selected based on the needs of a patient. For example, based on optical coherence tomography (OCT) analysis of a patient's eye, corrective lenses may be required having particular dioptric power values. Note that the sag function that is selected in operation 502 may be a sag function providing dioptric power values that are not the finalized values, but rather such sag function will be further refined in the operations below to provide optical performance having the desired dioptric power levels.

At operation 504, one or more limits of the input parameters of the sag function are determined including one or more of: a minimum or a maximum number of echelettes in a diffractive structure included as part of the sag function, a minimum or maximum radii of echelettes in the diffractive structure, or a total area of the diffractive structure.

At operation 506, the input parameters of the sag function are determined, the input parameters including one or more of: a radius of at least one echelette in the diffractive structure and the profile of a transition zone corresponding to the portion of the sag profile between the at least one echelette and an echelette adjacent to the at least one echelette. In some embodiments, the input parameters and/or limits may include: step heights and phase offsets of echelettes of an exemplary diffractive structure, geometrical profile of echelettes, the number of echelettes, and a diffractive structure radius.

At operation 508, values for the input parameters are determined based on the one or more limits. Determining values for the input parameters may be facilitated by computing module 420 executing an optimization algorithm according to any of the approaches described hereinabove.

At operation 510, an IOL with an optical profile comprising the optimized sag function is formed based on the values for the input parameters. Such an IOL provides at least one of the intermediate focus or the near focus with the one or more desired dioptric power values having non-integer multiple values (e.g., 2.1 D, 3.4 D) in addition to balanced energy distribution in-between the focal points of the intermediate focus and near focus. In some embodiments, the IOL may be formed based on the input parameters (e.g., number/radius of echelettes, peripheral refractive element radius (Rₒ), diffractive structure radius, step heights, and phase offsets of diffractive structure echelettes) as well as the computed control parameters obtained using appropriate methods, systems, and devices typically used for manufacturing lenses, as known to one of ordinary skill in the art.

In some embodiments, operations 502-508 may be performed by controller 402. In some embodiments, operations 502-508 of method 500 are performed by one system (e.g., system 400) while operation 510 may be performed by a lens manufacturing system. In other embodiments, both operations 502-510 (e.g., optimization and manufacturing the IOL) are performed by a lens manufacturing system (e.g., system 400).

As mentioned above, in some embodiments, the desired dioptric powers for intermediate and near focus are determined based on patient-specific visual requirements, ophthalmic conditions, and/or ocular characteristics of the patient. For example, such ophthalmic conditions may include one or more of: cataracts, presbyopia, refractive errors, aphakia, astigmatism, anisometropia, and/or post-operative refractive error. Accordingly, some embodiments include, determining, based on OCT measurements of the patient, an ophthalmic biometry of an eye of a patient, and determining a condition of the eye based on the ophthalmic biometry. The target add powers (i.e., desired dioptric power) are determined based on the condition of the eye and patient-specific visual requirements.

In some embodiments, method 500 may include determining, prior to forming the IOL, an optical performance of the IOL. For example, the optical performance of a customized IOL may be evaluated and further selected based on one or more optical parameters comprising: VA, MTF, contrast sensitivity, or energy distribution, as well as halo. Thus method 500 may, in some embodiments, include adjusting, based on the optical performance, the one or more parameters of the sag function. And some embodiments above may include, determining, prior to forming the IOL, an optical performance of the IOL based on one or more optical parameters comprising: VA, MTF, contrast sensitivity, and/or energy distribution, as well as halo.

The embodiments described above advantageously provide improved diffractive surface freedom in IOL design. Diffractive freedom in IOL design provided by the embodiments describe herein may be utilized to increase energy efficiency of the IOL. The energy concept is advantageous in IOL design and is closely related to the MTF distribution and VA curve. Therefore, the extra diffractive surface freedom may be utilized for effective energy control and distribution throughout the optic axis, yielding better vision, both designated points (distant, intermediate, near) and other intervals in between them to contribute to the VA curve. Thus, with customized IOL design that takes advantage of diffractive surface freedom, IOLs in accordance with the embodiments described above may enjoy improved VA, energy efficiency, and general reduction of visual disturbances like halo.

Additionally, the embodiments described herein provide a multifocal intraocular lens having a reduced visual disturbances such as halo, starburst, and glare. In the multifocal IOL, according to certain the embodiments described herein, visual disturbances and spherical aberrations (due to a diffractive lens element having dispersion properties of the lens material) are reduced by a diffractive structure with a number of echelettes selected according to an optimization algorithm. In particular, the reduction of visual disturbances of the IOL can be increased by performing an optimization algorithm with respect to the number of echelettes, step heights and phase offsets of the echelettes, and the radii of refractive elements. Such an optimization algorithm provides a wider variety of design choices to increase reduction of visual disturbances. For example, by allowing the radius of the peripheral refractive element to be adjusted while adjusting the number of echelettes, more precise control of visual disturbances may be achieved. Therefore, the embodiments described herein ensure a seamless and comfortable visual experience for patients, setting a new benchmark in IOL technology.

### Example Flow Diagram

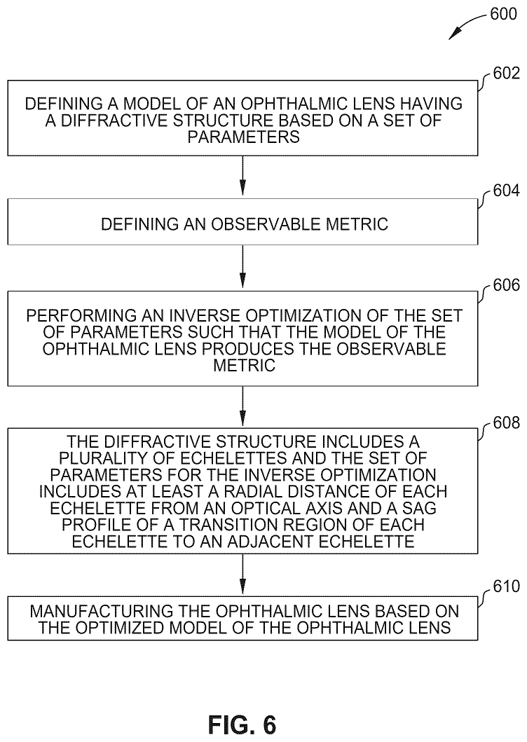

FIG. 6 illustrates flow diagram 600 according to an example embodiment. For example, flow diagram 600 may be for IOL 100 with diffractive structure 114 shown in FIGS. 1 and 1A. For example, flow diagram 600 may be to determine an optimal design of IOL 100 with diffractive structure 114 based on one or more performance metrics (e.g., VA distribution 310A, MTF distribution 310B, MTF distribution 310C, a halo profile). Flow diagram 600 may be configured to design IOL 100 with customized and optimized echelettes to obtain one or more desired optical powers (e.g., near, intermediate, distance), while preserving visual quality (e.g., VA, MTF) and reducing photic phenomena (e.g., halo). Flow diagram 600 may be further configured to determine a geometry (e.g., sag profile of diffractive structure 114) of IOL 100 to produce the desired multifocality and diffracted energy distributions.

Flow diagram 600 may be further configured to provide improved design freedom (e.g., non-periodic echelette radii, affine power function transition regions). Flow diagram 600 may be further configured to provide custom powers for one or more intermediate or near focal points (e.g., non-integer multiples). Flow diagram 600 may be further configured to provide improved optical performance (e.g., high energy utilization, MTF, and visual quality). Flow diagram 600 may be further configured to provide reduced visual disturbances (e.g., low halo effect). Flow diagram 600 may be further configured to adjust (e.g., optimize) a set of lens parameters of the IOL to produce one or more desired metrics (e.g., through-focus MTF for a defocus range, reduced halo profile).

It is to be appreciated that not all operations in FIG. 6 are needed to perform the disclosure provided herein. Further, some of the operations may be performed simultaneously, sequentially, and/or in a different order than shown in FIG. 6. Flow diagram 600 shall be described with reference to FIGS. 1-5. However, flow diagram 600 is not limited to those example embodiments. Although flow diagram 600 is shown in FIG. 6 as a stand-alone method, the embodiments of this disclosure can be used with other apparatuses, systems, and/or methods, such as, but not limited to, elements in FIGS. 1-5, e.g., IOL 100, diffractive structure 114, transition region 220, VA distribution 310A, MTF distribution 310B, MTF distribution 310C, system 400, and/or method 500. In some embodiments, flow diagram 600 may be implemented by one or more models or algorithms (e.g., an optimization algorithm) run on one or more processors and/or computing devices based on one or more instructions stored in one or more memories (e.g., system 400).

In operation 602, as shown in the example of FIGS. 1-4, a model of an ophthalmic lens (e.g., using specialized software such as ZEMAX) based on a set of parameters may be defined. In some embodiments, the model of the ophthalmic lens may include a diffractive structure (e.g., diffractive structure 114) configured to provide diffracted optical energy distributions for one or more desired optical powers. In some embodiments, the diffractive structure may include a plurality of echelettes configured to provide one or more diffractive steps. In some embodiments, each echelette may be arranged at a radial distance from an optical axis of the ophthalmic lens such that radii of the plurality of echelettes are non-periodic. In some embodiments, each echelette has a transition region connecting the echelette to an adjacent echelette such that the transition region is not limited to a simple quadratic phase but an affine power function.

In some embodiments, the set of parameters defining the model may include one or more lens parameters of the ophthalmic lens, a geometry of the ophthalmic lens, a geometry of the diffractive structure of the ophthalmic lens (e.g., diffractive structure 114), one or more patient biometry data (e.g., pupil size), or a combination thereof. In some embodiments, the one or more lens parameters of the ophthalmic lens may include the one or more desired optical powers. In some embodiments, for example, the one or more desired optical powers may include an intermediate add power for an intermediate focus and a near add power for a near focus.

In some embodiments, defining the model of the ophthalmic lens may include defining one or more constraints of the geometry of the diffractive structure. In some embodiments, the one or more constraints may include a number of echelettes of the plurality of echelettes, a range of radial distance for each echelette, a total area of the diffractive structure, or a combination thereof. In some embodiments, the one or more constraints may further include a radial distance, a step height, a phase offset, a sag profile of a transition region (e.g., transition region 220), or a combination thereof of one or more echelettes of the diffractive structure. In some embodiments, the sag profile of the transition region may be defined by Equation (6).

In operation 604, as shown in the example of FIGS. 1-4, an observable metric (e.g., MTF distribution, halo profile, etc.) may be defined. In some embodiments, the observable metric may include MTF. In some embodiments, the observable metric may include MTF for a range of defocus. In some embodiments, the observable metric may include a halo profile (e.g., halo below a certain threshold). In some embodiments, the observable metric may include an MTF metric, a photopic MTF metric, a photopic peak MTF metric, a visual acuity metric, a halo profile, MTFa, photopic MTFa, an optical transfer function, a point spread function, a combination thereof, or a derivative thereof. In some embodiments, the observable metric may include a MTF for a range of defocus and a halo profile for the ophthalmic lens.

In some embodiments, the observable metric may include a through-focus MTF. In some embodiments, for example, the observable metric may include a through-focus monochromatic MTF (e.g., at 550 nm). In some embodiments, for example, the observable metric may include a through-focus polychromatic MTF (e.g., photopic). In some embodiments, the observable metric may include a through-focus point spread function (PSF). In some embodiments, for example, the observable metric may include a through-focus monochromatic PSF (e.g., at 550 nm). In some embodiments, for example, the observable metric may include a through-focus polychromatic PSF (e.g., photopic). In some embodiments, the observable metric may include MTFa. In some embodiments, for example, the observable metric may include monochromatic MTFa (e.g., at 550 nm). In some embodiments, for example, the observable metric may include polychromatic MTFa (e.g., photopic).

In operation 606, as shown in the example of FIGS. 1-4, an inverse optimization of the set of parameters may be performed such that the model of the ophthalmic lens produces the observable field or the observable metric. In some embodiments, the inverse optimization is configured to optimize a shape of the diffractive structure (e.g., diffractive structure 114) of the ophthalmic lens based on the observable metric (e.g., through-focus MTF) and thereby generate multifocality for one or more desired optical powers (e.g., near, intermediate, distance) while preserving visual quality (e.g., VA, MTF) and reducing photic phenomena (e.g., halo). In some embodiments, the inverse optimization may optimize the radii and shape of the echelettes of the diffractive structure based on one or more observable metrics (e.g., MTF, halo profile, etc.).

In some embodiments, performing the inverse optimization may include performing an inverse optimization of the set of parameters (e.g., diffractive structure 114) such that the model of the ophthalmic lens produces a first observable metric (e.g., through-focus MTF) and produces a second observable metric (e.g., halo profile).

In some embodiments, performing the inverse optimization may include using an optimization algorithm. In some embodiments, the optimization algorithm may include gradient descent. In some embodiments, for example, the optimization algorithm may include sequential gradient descent for the diffractive structure (e.g., diffractive structure 114) until the desired observable metric is produced (e.g., through-focus MTF and halo profile). In some embodiments, for example, the optimization algorithm may include sequential gradient descent for each echelette of the diffractive structure at a first observable metric (e.g., through-focus MTF) and at a second observable metric (e.g., halo profile). In some embodiments, for example, the optimization algorithm may include sequential gradient descent for a radial distance of each echelette (e.g., radial distance R₁ 216a) and a shape (sag profile) of a transition region of each echelette (e.g., transition region 220) at a first observable metric (e.g., through-focus MTF) and at a second observable metric (e.g., halo profile). In some embodiments, for example, the optimization algorithm may include sequential gradient descent for each echelette of the diffractive structure at a plurality of spatial frequencies (e.g., design optimization at first MTF distribution (50 lp/mm), design optimization at second MTF distribution (100 lp/mm), design optimization at third MTF distribution (e.g., 80 lp/mm)).

In some embodiments, the optimization algorithm may include simulated annealing, genetic algorithm, swarm optimization, gradient descent, finite difference, interpolation, population models, regression, parameter adaptation, supervised machine learning, unsupervised machine learning, neural networks, classification models, clustering, vector quantization, stochastic gradient descent, implicit updates, leaky averaging, momentum methods, AdaGrad, backpropagation, RMSProp, Adam, or a combination thereof.

In some embodiments, performing the inverse optimization may include calculating MTFa (e.g., monochromatic, polychromatic) based on the observable metric. In some embodiments, performing the inverse optimization may further include determining MTF (e.g., monochromatic, polychromatic) of the ophthalmic lens based on the calculated MTFa. In some embodiments, performing the inverse optimization may further include using the MTF as one or more inputs to the model to adjust (e.g., optimize) the set of parameters. In some embodiments, the diffractive surface (e.g., diffractive structure 114) may be determined and adjusted (e.g., optimized) based on the model of IOL 100 (e.g., ZEMAX) and the set of parameters.

In some embodiments, a radial distance and a shape (sag profile) of a transition region of each echelette of the diffractive structure (e.g., diffractive structure 114) may be optimized through an iterative design process that evaluates optical performance (e.g., MTF, halo profile, etc.). In some embodiments, for example, the optimization process (e.g., inverse optimization) may prioritize MTF values and then halo profile values. In some embodiments, for example, the optimization process (e.g., inverse optimization) may prioritize halo profile values and then MTF values. In some embodiments, the radial distance of each echelette and the shape (sag profile) of the transition region of each echelette of the diffractive structure (e.g., diffractive structure 114) may be optimized based on one or more observable metrics (e.g., MTF, halo profile), for example, through an iterative design process that adjusts the radial distance of each echelette and the shape (sag profile) of the transition region of each echelette to fine tune the multifocality and vision quality (e.g., MTF) while simultaneously reducing photic phenomena (e.g., halo profile).

In operation 608, as shown in the example of FIGS. 1-4, the set of parameters for the inverse optimization may include at least a radial distance of each echelette from the optical axis (e.g., optical axis 112) and a sag profile of a transition region (e.g., transition region 220) of each echelette to an adjacent echelette of the diffractive structure. In some embodiments, the set of parameters may further include a number of echelettes of the plurality of echelettes, a range of radial distance for each echelette, a total area of the diffractive structure, or a combination thereof.

In operation 610, as shown in the example of FIGS. 1-4, an ophthalmic lens (e.g., IOL 100 with diffractive structure 114, etc.) may be manufactured based on the optimized model after the inverse optimization determined in operation 606. In some embodiments, the optimized model may be manufactured by an optical manufacturing system (e.g., a 3D printer). In some embodiments, the manufacturing the ophthalmic lens may include additive manufacturing, bonding, 3D printing, spin coating, subtractive manufacturing, lithography, photolithography, inducing stress, extrusion, molding, layering, ion exchange, polymerization, diffusion, irradiation, deposition, or a combination thereof.

It is to be understood that the phraseology or terminology herein is for the purpose of description and not of limitation, such that the terminology or phraseology of the present specification is to be interpreted by those skilled in relevant art(s) in light of the teachings herein.

The above examples are illustrative, but not limiting, of the embodiments of this disclosure. Other suitable modifications and adaptations of the variety of conditions and parameters normally encountered in the field, and which would be apparent to those skilled in the relevant art(s), are within the spirit and scope of the disclosure.

While specific embodiments have been described above, it will be appreciated that the embodiments may be practiced otherwise than as described. The description is not intended to limit the scope of the claims.

It is to be appreciated that the Detailed Description section, and not the Summary and Abstract sections, is intended to be used to interpret the claims. The Summary and Abstract sections may set forth one or more, but not all example embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein.

The breadth and scope of the embodiments should not be limited by any of the above-described example embodiments, but should be defined only in accordance with the following claims and their equivalents.

The present disclosure may also be described in accordance with the following clauses:

Clause 1. An ophthalmic lens comprising:
an optical profile centered around an optical axis, the optical profile comprising a diffractive structure including a freeform surface configured to provide:
a first optical energy distribution along the optical axis corresponding to a distance focus for distance vision;
a second optical energy distribution along the optical axis corresponding to an intermediate focus for intermediate vision having an intermediate add power; and
a third optical energy distribution along the optical axis corresponding to a near focus for near vision having a near add power,
wherein the near add power is equivalent to a non-integer multiple of the intermediate add power.

Clause 2. The ophthalmic lens of clause 1, wherein the freeform surface is further configured to achieve one or more additional optical energy distributions along the optical axis between any of the first, second, and third optical energy distributions.

Clause 3. The ophthalmic lens of clause 1 or clause 2, wherein the diffractive structure includes a range of 6 to 30 echelettes.

Clause 4. The ophthalmic lens of any one of clauses 1 to 3, wherein a transition zone profile of adjacent echelettes of the diffractive structure corresponds to a non-linear polynomial form.

Clause 5. The ophthalmic lens of clause 4, wherein the non-linear polynomial form corresponds to y=ax^{k}+b, where k, a, and b are rational numbers.

Clause 6. The ophthalmic lens of any one of clauses 1 to 5, wherein one or more desired dioptric powers for intermediate and near focus are determined based on patient specific visual requirements, ophthalmic conditions, ocular characteristics, or a combination thereof.

Clause 7. The ophthalmic lens of clause 6, wherein the ophthalmic conditions comprise cataracts, presbyopia, refractive errors, aphakia, astigmatism, anisometropia, post-operative refractive error, or a combination thereof.

Clause 8. A method of forming an ophthalmic lens, the method comprising:
determining a sagitta (sag) function based on one or more dioptric power values for at least one of intermediate focus or near focus, the one or more dioptric power values being integer or non-integer multiples of one another;
determining one or more limits of the sag function including a minimum or a maximum number of echelettes in a diffractive structure, a minimum or a maximum radii of echelettes in the diffractive structure, a total area of the diffractive structure, or a combination thereof;
determining one or more parameters of the sag function, the one or more parameters including a radius of at least one echelette in the diffractive structure, a transition zone sag profile corresponding to the at least one echelette and an echelette adjacent to the at least one echelette, or a combination thereof;
determining values for the one or more parameters based on the one or more limits and the one or more dioptric power values; and
forming the ophthalmic lens based on the values for the one or more parameters.

Clause 9. The method of clause 8, wherein the one or more parameters further include a number of echelettes, a radius of the diffractive structure, a radius of a peripheral refractive portion, a total area of the diffractive structure, or a combination thereof.

Clause 10. The method of clause 8 or clause 9, wherein the transition zone sag profile corresponds to a non-linear polynomial form, and wherein the one or more parameters of the sag function further includes the non-linear polynomial form y=ax^{k}+b, wherein the one or more parameters further include a, b, and k.

Clause 11. The method of any one of clauses 8 to 10, wherein the one or more dioptric power values for intermediate and near focus are determined based on patient specific visual requirements, ophthalmic conditions, ocular characteristics, or a combination thereof.

Clause 12. The method of clause 11, wherein the ophthalmic conditions comprise cataracts, presbyopia, refractive errors, aphakia, astigmatism, anisometropia, post-operative refractive error, or a combination thereof, and wherein the one or more limits further include a maximum radius of the ophthalmic lens, a minimum or a maximum radius of a central diffractive portion, a minimum or a maximum radius of a peripheral refractive portion, a lens base power, a refractive index of a lens body, or a combination thereof.

Clause 13. The method of any one of clauses 8 to 12, further comprising:
determining, prior to forming the ophthalmic lens, an optical performance of the ophthalmic lens based on one or more optical parameters comprising a MTF, a contrast sensitivity, an energy distribution, or a combination thereof; and
adjusting, based on the optical performance, the one or more parameters of the sag function.

Clause 14. The method of any one of clauses 8 to 13, wherein determining the sag function based on the one or more dioptric power values for intermediate and near focus comprises:
determining, based on OCT measurements of a patient, an ophthalmic biometry of an eye of the patient;
determining a condition of the eye based on the ophthalmic biometry; and
determining, based on the condition of the eye and one or more patient specific visual requirements, a first target add power value for near focus, a second target add power value for intermediate focus, more secondary foci, or a combination thereof.

Clause 15. The method of any one of clauses 8 to 14, wherein the one or more parameters further include a step height corresponding to the at least one echelette, a phase offset corresponding to the at least one echelette, or a combination thereof.

Clause 16. An ophthalmic lens comprising:
a diffractive structure configured to modify a wavefront of light passing through the ophthalmic lens and provide diffracted optical energy distributions for one or more desired optical powers, wherein the diffractive structure comprises:
   a plurality of echelettes configured to provide one or more diffractive steps, wherein at least one echelette is arranged at a radial distance from an optical axis of the ophthalmic lens such that radii of the plurality of echelettes are non-periodic, and thus can be non-linear in r² space, and wherein at least one echelette has a transition region connecting the at least one echelette to an adjacent echelette such that the transition region is not limited to a simple quadratic phase but an affine power function,
wherein the diffractive structure is configured to provide at least:
   a first optical energy distribution along the optical axis corresponding to a distance focus for distance vision,
   a second optical energy distribution along the optical axis corresponding to an intermediate focus for intermediate vision, and
   a third optical energy distribution along the optical axis corresponding to a near focus for near vision.

Clause 17. The ophthalmic lens of clause 16, wherein:
the intermediate focus has an intermediate add power,
the near focus has a near add power, and
the near add power is equivalent to an integer or a non-integer multiple of the intermediate add power.

Clause 18. The ophthalmic lens of clause 16 or clause 17, wherein the diffractive structure is further configured to provide a fourth optical energy distribution, a fifth optical energy distribution, or both along the optical axis.

Clause 19. The ophthalmic lens of any one of clauses 16 to 18, wherein a number of echelettes of the plurality of echelettes is in a range of 5 to 25.

Clause 20. The ophthalmic lens of any one of clauses 16 to 19, wherein the transition region for the at least one echelette is based at least in part on an affine power function with an offset defined as:

$$z ( r ) = {ar}^{k} + b$$

where z(r) is displacement of the diffractive sag profile of the transition region at a radial distance r from the optical axis of the ophthalmic lens, and a, b, and k are rational numbers defining a shape of the diffractive sag profile.

Clause 21. The ophthalmic lens of any one of clauses 16 to 20, wherein the one or more desired optical powers are based at least in part on a patient specific visual requirement, an ophthalmic condition, an ocular characteristic, or a combination thereof.

Clause 22. The ophthalmic lens of any one of clauses 16 to 21, wherein radii of the plurality of echelettes and diffractive sag profiles of the transition regions of the plurality of echelettes are based on one or more performance metrics of the ophthalmic lens.

Clause 23. The ophthalmic lens of clause 22, wherein the one or more performance metrics comprises modulation transfer function (MTF) of the ophthalmic lens for a range of defocus.

Clause 24. The ophthalmic lens of clause 22 or clause 23, wherein the one or more performance metrics comprises a halo profile of the ophthalmic lens.

Clause 25. The ophthalmic lens of any one of clauses 16 to 24, wherein radii of the plurality of echelettes and diffractive sag profiles of the transition regions of the plurality of echelettes are configured to increase MTF of the ophthalmic lens and to reduce a halo profile of the ophthalmic lens relative to a diffractive multifocal ophthalmic lens that utilizes integer or non-integer multiples between desired optical powers.

Clause 26. A method of designing an ophthalmic lens having a diffractive structure, the method comprising:
defining a model of the ophthalmic lens based on a set of parameters, wherein the model of the ophthalmic lens comprises a diffractive structure configured to provide diffracted optical energy distributions for one or more desired optical powers;
defining an observable metric; and
performing an inverse optimization of the set of parameters such that the model of the ophthalmic lens produces the observable metric,
wherein the diffractive structure comprises a plurality of echelettes configured to provide one or more diffractive steps, wherein at least one echelette is arranged at a radial distance from an optical axis of the ophthalmic lens such that radii of the plurality of echelettes are non-periodic, and thus can be non-linear in r² space, and wherein at least one echelette has a transition region connecting the at least one echelette to an adjacent echelette such that the transition region is not limited to a simple quadratic phase but an affine power function.

Clause 27. The method of clause 26, wherein the observable metric comprises a monochromatic MTF, a photopic MTF, a photopic peak MTF, a visual acuity, a halo profile, an area under the MTF (MTFa), a photopic MTFa, an optical transfer function, a point spread function, a combination thereof, or a derivative thereof.

Clause 28. The method of clause 27, wherein the observable metric comprises a MTF for a range of defocus and a halo profile for the ophthalmic lens.

Clause 29. The method of any one of clauses 26 to 28, wherein the set of parameters defining the model comprises one or more lens parameters of the ophthalmic lens, a geometry of the ophthalmic lens, the diffractive structure of the ophthalmic lens, one or more patient biometry data, or a combination thereof.

Clause 30. The method of clause 29, wherein the one or more lens parameters of the ophthalmic lens comprises the one or more desired optical powers, wherein the one or more desired optical powers comprises an intermediate add power for an intermediate focus and a near add power for a near focus.

Clause 31. The method of any one of clauses 26 to 30, wherein the defining the model of the ophthalmic lens comprises defining one or more constraints of the diffractive structure.

Clause 32. The method of clause 31, wherein the one or more constraints comprises a number of echelettes of the plurality of echelettes, a range of radial distance for each echelette, a total area of the diffractive structure, or a combination thereof.

Clause 33. The method of clause 32, wherein the one or more constraints further comprises a radial distance, a step height, a phase offset, a sag profile of the transition region, or a combination thereof of one or more echelettes of the diffractive structure.

Clause 34. The method of any one of clauses 26 to 33, wherein the performing the inverse optimization comprises using an optimization algorithm, wherein the optimization algorithm comprises gradient descent.

Clause 35. The method of any one of clauses 26 to 34, further comprising manufacturing the ophthalmic lens based on the model of the ophthalmic lens after the inverse optimization.

What is claimed is:

1. An ophthalmic lens comprising:
a diffractive structure configured to modify a wavefront of light passing through the ophthalmic lens and provide diffracted optical energy distributions for one or more desired optical powers, wherein the diffractive structure comprises:
a plurality of echelettes configured to provide one or more diffractive steps, wherein at least one echelette is arranged at a radial distance from an optical axis of the ophthalmic lens such that radii of the plurality of echelettes are non-periodic, and thus can be non-linear in r² space, and wherein at least one echelette has a transition region connecting the at least one echelette to an adjacent echelette such that the transition region is not limited to a simple quadratic phase but an affine power function, wherein the diffractive structure is configured to provide at least:
a first optical energy distribution along the optical axis corresponding to a distance focus for distance vision,
a second optical energy distribution along the optical axis corresponding to an intermediate focus for intermediate vision, and
a third optical energy distribution along the optical axis corresponding to a near focus for near vision.

2. The ophthalmic lens of claim 1, wherein:
the intermediate focus has an intermediate add power,
the near focus has a near add power, and
the near add power is equivalent to an integer or a non-integer multiple of the intermediate add power.

3. The ophthalmic lens of claim 1, wherein the diffractive structure is further configured to provide a fourth optical energy distribution, a fifth optical energy distribution, or both along the optical axis.

4. The ophthalmic lens of claim 1, wherein a number of echelettes of the plurality of echelettes is in a range of 5 to 25.

5. The ophthalmic lens of claim 1, wherein the transition region for the at least one echelette is based at least in part on an affine power function with an offset defined as:
$$z ( r ) = {ar}^{k} + b$$
where z(r) is displacement of the diffractive sag profile of the transition region at a radial distance r from the optical axis of the ophthalmic lens, and a, b, and k are rational numbers defining a shape of the diffractive sag profile.

6. The ophthalmic lens of claim 1, wherein the one or more desired optical powers are based at least in part on a patient specific visual requirement, an ophthalmic condition, an ocular characteristic, or a combination thereof.

7. The ophthalmic lens of claim 1, wherein radii of the plurality of echelettes and diffractive sag profiles of the transition regions of the plurality of echelettes are based on one or more performance metrics of the ophthalmic lens.

8. The ophthalmic lens of claim 7, wherein the one or more performance metrics comprises modulation transfer function (MTF) of the ophthalmic lens for a range of defocus.

9. The ophthalmic lens of claim 7, wherein the one or more performance metrics comprises a halo profile of the ophthalmic lens.

10. The ophthalmic lens of claim 1, wherein radii of the plurality of echelettes and diffractive sag profiles of the transition regions of the plurality of echelettes are configured to increase MTF of the ophthalmic lens and to reduce a halo profile of the ophthalmic lens relative to a diffractive multifocal ophthalmic lens that utilizes integer or non-integer multiples between desired optical powers.

11. A method of designing an ophthalmic lens having a diffractive structure, the method comprising:
defining a model of the ophthalmic lens based on a set of parameters, wherein the model of the ophthalmic lens comprises a diffractive structure configured to provide diffracted optical energy distributions for one or more desired optical powers;
defining an observable metric; and
performing an inverse optimization of the set of parameters such that the model of the ophthalmic lens produces the observable metric,
wherein the diffractive structure comprises a plurality of echelettes configured to provide one or more diffractive steps, wherein at least one echelette is arranged at a radial distance from an optical axis of the ophthalmic lens such that radii of the plurality of echelettes are non-periodic, and thus can be non-linear in r² space, and wherein at least one echelette has a transition region connecting the at least one echelette to an adjacent echelette such that the transition region is not limited to a simple quadratic phase but an affine power function.

12. The method of claim 11, wherein the observable metric comprises a monochromatic MTF, a photopic MTF, a photopic peak MTF, a visual acuity, a halo profile, an area under the MTF (MTFa), a photopic MTFa, an optical transfer function, a point spread function, a combination thereof, or a derivative thereof.

13. The method of claim 12, wherein the observable metric comprises a MTF for a range of defocus and a halo profile for the ophthalmic lens.

14. The method of claim 11, wherein the set of parameters defining the model comprises one or more lens parameters of the ophthalmic lens, a geometry of the ophthalmic lens, the diffractive structure of the ophthalmic lens, one or more patient biometry data, or a combination thereof.

15. The method of claim 14, wherein the one or more lens parameters of the ophthalmic lens comprises the one or more desired optical powers, wherein the one or more desired optical powers comprises an intermediate add power for an intermediate focus and a near add power for a near focus.

16. The method of claim 11, wherein the defining the model of the ophthalmic lens comprises defining one or more constraints of the diffractive structure.

17. The method of claim 16, wherein the one or more constraints comprises a number of echelettes of the plurality of echelettes, a range of radial distance for each echelette, a total area of the diffractive structure, or a combination thereof.

18. The method of claim 17, wherein the one or more constraints further comprises a radial distance, a step height, a phase offset, a sag profile of the transition region, or a combination thereof of one or more echelettes of the diffractive structure.

19. The method of claim 11, wherein the performing the inverse optimization comprises using an optimization algorithm, wherein the optimization algorithm comprises gradient descent.

20. The method of claim 11, further comprising manufacturing the ophthalmic lens based on the model of the ophthalmic lens after the inverse optimization.
